(19) United States
(12) Patent Application Publication
(10) Pub. No.: US 2026/0104724 A1
(43) Pub. Date: Apr. 16, 2026

(54) ADAPTIVE HEADROOM CONTROL FOR LOW DROPOUT REGULATOR (LDO)

(71) Applicant: TEXAS INSTRUMENTS INCORPORATED, Dallas, TX (US)

(72) Inventors: Reza Sharifi, Sunnyvale, CA (US); Yat Hei Lam, San Jose, CA (US); Pengyu Gu, San Francisco, CA (US)

(21) Appl. No.: 19/331,252

(22) Filed: Sep. 17, 2025

Related U.S. Application Data
(60) Provisional application No. 63/705,732, filed on Oct. 10, 2024.

(51) Int. Cl. G05F 1/575; G05F 1/59

(52) U.S. Cl. CPC G05F 1/575; G05F 1/59

(57) ABSTRACT

An electronic circuit comprising an output terminal, and a voltage regulator comprising: a supply terminal; a reference input terminal; a first transistor having a control terminal, and first and second current path terminals, the first current path terminal coupled to the output terminal, the second current path terminal coupled to the supply terminal. A second transistor having a control terminal, and first and second current path terminals, the first current path terminal coupled to the output terminal, the second current path terminal coupled to the supply terminal, and the control terminal coupled to the control terminal of the first transistor. A current source coupled between the supply terminal and the second current path terminal of the second transistor. An auxiliary circuit senses a voltage across the first and second current path terminals of the second transistor and generate a voltage adjustment signal based on the sensed voltage.

### RELATED APPLICATION

This application claims priority to U.S. Provisional Application No. 63/705,732, filed Oct. 10, 2024, entitled “Adaptive headroom control for high performance LDOs,” which is hereby incorporated by reference.

### TECHNICAL FIELD

The present disclosure relates generally to an electronic system and method, and, in particular embodiments, to adaptive headroom control for a low dropout regulator.

### BACKGROUND

A low dropout regulator (LDO) generally requires a minimum headroom, (i.e., the voltage drop across a LDO's internal pass transistor necessary for proper regulation), for proper operation. The minimum headroom may depend on operating condition, process variation and temperature of the LDO. An LDO generally requires a fixed worst case headroom to ensure the LDO meets performance under all operating conditions (temperature and load) and process variations.

### SUMMARY

In accordance to an embodiment, an electronic circuit includes: an output terminal; a voltage regulator including: a supply terminal; a reference input terminal; a first transistor having a control terminal, and first and second current path terminals, the first current path terminal of the first transistor coupled to the output terminal, the second current path terminal of the first transistor coupled to the supply terminal of the voltage regulator; a second transistor having a control terminal, and first and second current path terminals, the first current path terminal of the second transistor coupled to the output terminal, the second current path terminal of the second transistor coupled to the supply terminal of the voltage regulator, and the control terminal of the second transistor coupled to the control terminal of the first transistor; and a current source coupled between the supply terminal of the voltage regulator, and the second current path terminal of the second transistor, where the voltage regulator is configured to provide a regulated voltage at the output terminal based on the reference input terminal; and an auxiliary circuit configurable to: sense a voltage across the first and second current path terminals of the second transistor; and generate a voltage adjustment signal based on the sensed voltage.

In accordance to an embodiment, an electronic circuit includes: an output terminal; a voltage regulator including: a supply terminal; a reference input terminal; a first transistor having a control terminal, and first and second current path terminals, the first current path terminal of the first transistor coupled to the output terminal, the second current path terminal of the first transistor coupled to the supply terminal of the voltage regulator; a second transistor having a control terminal, and first and second current path terminals, the first current path terminal of the second transistor coupled to the output terminal, the second current path terminal of the second transistor coupled to the supply terminal of the voltage regulator, and the control terminal of the second transistor coupled to the control terminal of the first transistor; a current source coupled between the supply terminal of the voltage regulator, and the second current path terminal of the second transistor; and a first amplifier having a first input coupled to the reference input terminal of the voltage regulator, a second input coupled to the output terminal, and an output coupled to the control terminal of the first transistor; and an auxiliary circuit including a second amplifier having a first input coupled to the first current path terminal of the second transistor, a second input coupled to the second current path terminal of the second transistor, and an output.

In accordance to an embodiment, an electronic circuit includes: an output terminal; a supply terminal; a first transistor having a control terminal, and first and second current path terminals, the first current path terminal of the first transistor coupled to the output terminal, the second current path terminal of the first transistor coupled to the supply terminal; a second transistor having a control terminal, and first and second current path terminals, the first current path terminal of the second transistor coupled to the output terminal, the second current path terminal of the second transistor coupled to the supply terminal, and the control terminal of the second transistor coupled to the control terminal of the first transistor; a current source coupled between the supply terminal and the second current path terminal of the second transistor; a first amplifier having a first input coupled to a reference input terminal, a second input coupled to the output terminal, and an output coupled to the control terminal of the first transistor; and an auxiliary circuit including a second amplifier having a first input coupled to the first current path terminal of the second transistor, a second input coupled to the second current path terminal of the second transistor, and an output.

In accordance to an embodiment, an electronic circuit includes: an output terminal; a supply terminal; a first transistor having a control terminal, and first and second current path terminals, the first current path terminal of the first transistor coupled to the output terminal, the second current path terminal of the first transistor coupled to the supply terminal; a second transistor having a control terminal, and first and second current path terminals, the first current path terminal of the second transistor coupled to the output terminal, the second current path terminal of the second transistor coupled to the supply terminal, and the control terminal of the second transistor coupled to the control terminal of the first transistor; a current source coupled between the supply terminal and the second current path terminal of the second transistor; an auxiliary circuit configurable to: sense a voltage across the first and second current path terminals of the second transistor; and generate a voltage adjustment signal based on the sensed voltage to the control terminals of the first transistor and the second transistor.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 depicts a schematic diagram of an example of an electronic circuit for adaptive LDO headroom control, in accordance with an embodiment of the present disclosure;

FIG. 2A depicts examples of simulation waveforms of various signals related to supply voltage adjustment by the voltage comparator, in an example; FIG. 2B depicts another example of supply voltage adjustment by the voltage comparator, in accordance with an embodiment of the present disclosure;

FIG. 3 depicts a schematic diagram of an example of an electronic circuit, which, in addition to the components of FIG. 1, further includes a digital control counter, in accordance with an embodiment of the present disclosure;

FIG. 4 depicts a schematic diagram of an example of an electronic circuit, wherein the voltage analyzing circuit is an analog circuit, in accordance with an embodiment of the present disclosure;

FIG. 5 depicts a schematic diagram of another example of an electronic circuit, wherein the voltage analyzing circuit bis an analog circuit, in accordance with an embodiment of the present disclosure.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In some cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

An LDO with a fixed minimum headroom may ensure proper operation. However, using a fixed minimum headroom may result in higher losses, which may reduce the system efficiency and battery life.

Some embodiments dynamically adjusts the headroom of an LDO to ensure losses are minimized while the LDO maintains target/intended performance parameters such PSRR, bandwidth, etc. To accomplish this, some embodiments include a sense circuit that continuously monitors the drain-source voltage (V_{D}S) of a transistor of the LDO and compares the V_{DS} to a saturation threshold voltage V_{DSAT}, which keeps the transistor in saturation while taking into consideration process, temperature and load variations of the transistor.

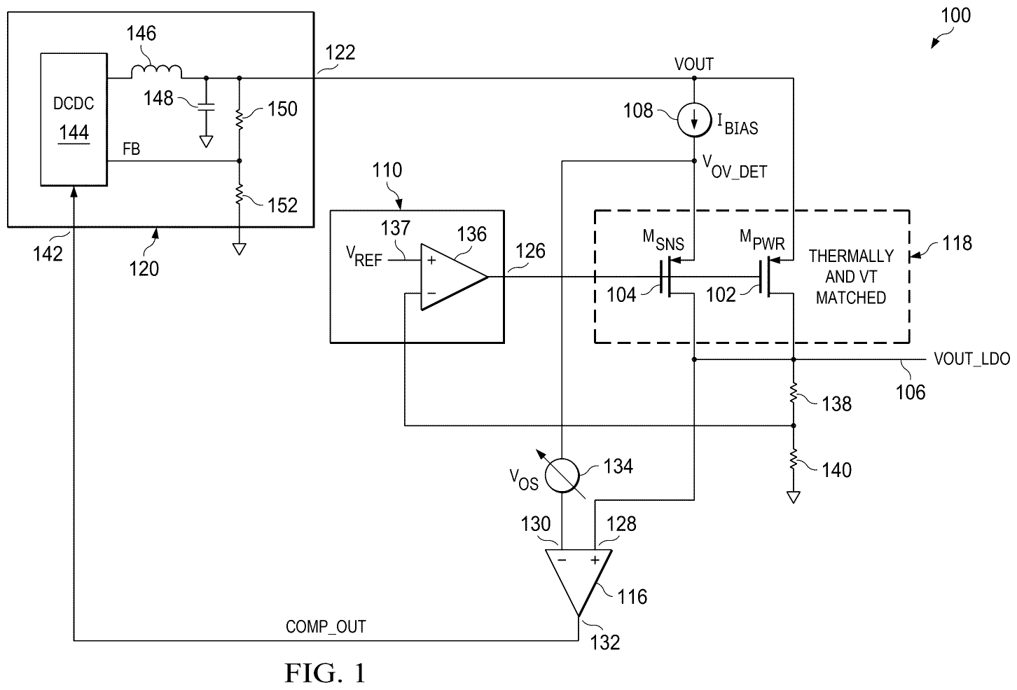

FIG. 1 depicts a schematic diagram of an electronic circuit 100 for adaptive LDO headroom control, according to an embodiment of the present disclosure. The electronic circuit 100, e.g., a voltage regulator, includes a first transistor 102, a second transistor 104, a bias current source 108, an amplifier 110, an auxiliary circuit 116, and a voltage converter 120. For a non-limiting example, both the first transistor 102 and the second transistor 104 are first field effect transistors (FETs) such as MOSFET. As shown in the example of FIG. 1, the first transistor 102 has a first current path terminal (e.g., a drain) coupled to an output terminal 106 of the electronic circuit 100 and a second current path terminal (e.g., a source) coupled to a supply terminal 122. The first transistor 102, also shown as the power transistor M_{PWR}, is a (e.g., passive) transistor configurable to provide a load current through the output terminal 106. The second transistor 104 has a source coupled to the bias current source 108 and a drain coupled to the output terminal 106. In an example, the second transistor 104 is a scaled down replica of the first transistor 102 under the same operating conditions (temperature and load) and process variations and thus has a same threshold voltage V_{TH} as the first transistor 102. The second transistor 104, also shown as the sense transistor M_{SNS}, is configurable to sense the drain-source voltage VDS of the first transistor 102. Control terminals (e.g., gates) of the first transistor and the second transistor, respectively, are both coupled to a current control terminal 126 of the amplifier 110. For a non-limiting example, the voltage converter 120 is a switching buck converter.

In one example, the current source 108 is coupled between the supply terminal 122 and the source of the second transistor 104. In one example, the current source 108 is configurable to provide a bias current through the second transistor 104 so that the gate-source voltage V_{GS} of the second transistor 104 is (e.g., almost) equal to its threshold voltage V_{TH}, which is the same threshold voltage of the first transistor 102. As such, the voltage V_{OV_DET} at the source of the second transistor 104 can be expressed as:

$${V}_{OV\_DET} = VOUT - {V}_{GSMPWR} + {V}_{T H}$$

wherein VOUT is a supply voltage at the supply terminal 122, and V_{GSMPWR} is the gate-source voltage of the first transistor 102.

In one example, the amplifier 110 generates a current control signal at the current control terminal 126 to the control terminal of the first transistor 102 and the control terminal of the second transistor 104 based on an output voltage VOUT_LDO at the output terminal 106. In one example, the amplifier 110 lowers voltages at the control terminals of the first transistor and the control terminal of the second transistor as the load current increases. In one example, the amplifier 110 includes a voltage amplifier 136 to generate the current control signal at the current control terminal 126 by comparing a reference voltage Vref at a reference input terminal 137 to the output voltage VOUT_LDO, which, in one example, is divided via a pair of resistors 138 and 140.

In one example, the auxiliary circuit 116 is or includes a comparator having a first input terminal 128 coupled to the drain of the first transistor 102 and configurable to receive a voltage at the drain of the first transistor 102 as its first input. In one example, the amplifier is an operational amplifier. In one example, the amplifier is a comparator.

In one example, the auxiliary circuit 116 also has a second input terminal 130 coupled to the source of the second transistor 104 and configurable to receive a voltage at the source of the second transistor 104 as its second input. In one example, the auxiliary circuit 116 generates a voltage adjustment signal COMP_OUT at an output terminal 132 according to the output voltage VOUT_LDO and the voltage V_{OV_DET} at the source of the second transistor 104. In one example, the output terminal 132 of the auxiliary circuit 116 is coupled to an input terminal 142 of the voltage converter 120 to provide the voltage adjustment signal COMP_OUT to the voltage converter 120.

In one example, the voltage converter 120 receives the voltage adjustment signal COMP_OUT at its input terminal 142 and adjusts a supply voltage VOUT at the supply terminal 122 according to the voltage adjustment signal. In one example, the voltage converter 120 includes a DC-DC converter 144 to generate the supply voltage VOUT through an inductor 146 and a capacitor 146 according to the voltage adjustment signal COMP_OUT. In one example, the DC-DC converter 144 further takes a feedback signal FB as its input, wherein the feedback signal FB is divided from the supply voltage VOUT via a pair of resistors 150 and 152.

In one example, the auxiliary circuit 116 is or includes a voltage comparator configurable to compare the output voltage VOUT_LDO at the output terminal 106/drain of the first transistor 102 and the voltage V_{OV_DET} at the source of the second transistor 104. As discussed above, V_{OV_DET}=VOUT−V_{GSMPR}+V_{TH}. It is appreciated that the first transistor 102 may operate in a saturation region when its drain-source voltage V_{DSMPR} is greater or equal to its saturation threshold voltage V_{DSAT} as shown below:

$${V}_{DSMPWR} = VOUT - VOUT\_LDO \geq {V}_{DSAT} = {V}_{GSMPWR} - {V}_{T H}$$

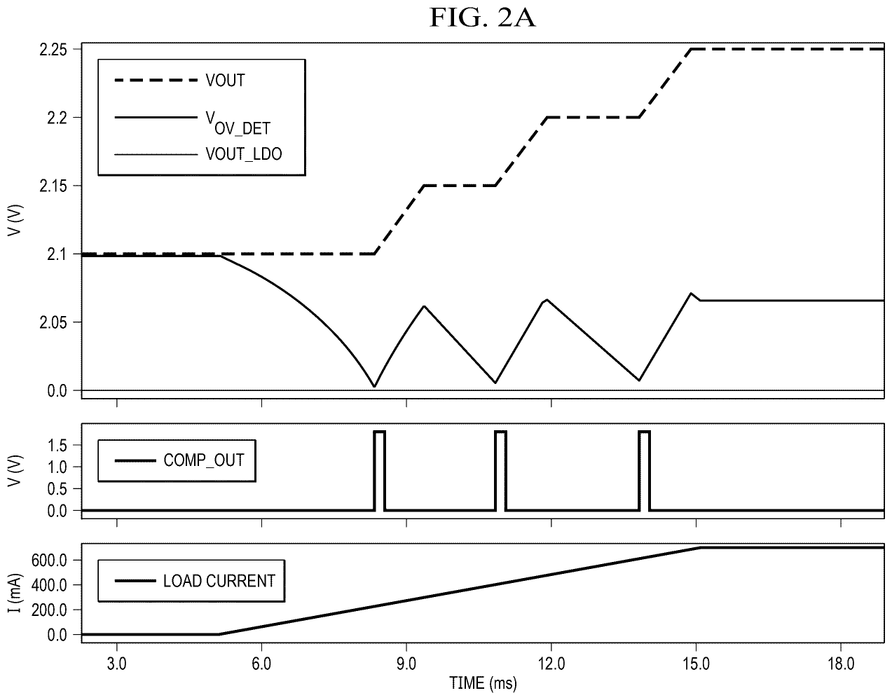

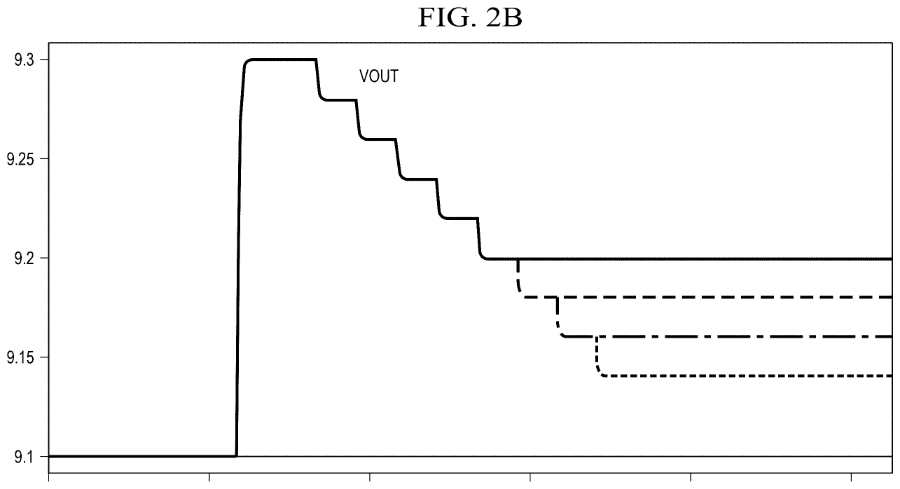

FIG. 2A depicts examples of simulation waveforms of various signals related to supply voltage adjustment by the voltage comparator, according to an embodiment of the present disclosure.

During normal operation, the first transistor 102 may initially operate in its saturation region. As the load current increases (e.g., over 200 mA) the amplifier 110 may lower the voltage at the control terminal of the first transistor 102, pushing the first transistor 102 towards a linear region. As a result, V_{OV_DET} may decrease and eventually reach the output voltage VOUT_LDO (e.g., at 2 V) indicating that the drain-source voltage of the first transistor 102 V_{DSMPR} is at its saturation threshold voltage V_{DSAT} and the first transistor 102 is about to enter into the linear region from the saturation region. At this point, the two inputs to the voltage comparator−VOUT_LDO and V_{OV_DET} are the same, causing the voltage comparator to generate a pulse (e.g., at 1.5V) in its voltage adjustment signal COMP_OUT as shown in FIG. 2A. In one example, the pulse in the voltage adjustment signal COMP_OUT causes the DC-DC converter 144 of the voltage converter 120 to increase the supply voltage VOUT at the supply terminal 122 by a pre-determined amount (e.g., 0.05 V) to provide more headroom for the LDO and to keep the first transistor 102 in its saturation region and out of the linear region as desired. As shown in FIG. 2A, the supply voltage VOUT may be adjusted incrementally in multiple steps/stages as the load current continues to increase.

FIG. 2B depicts another example of supply voltage adjustment by the voltage comparator, according to an embodiment of the present disclosure. In the embodiment of FIG. 2B, instead of increasing the supply voltage VOUT gradually, the voltage comparator 132 causes an increases in the supply voltage VOUT at the supply terminal 122 to a maximum value allowable for the first transistor 102 in a single step (e.g., from 9.1 V to 9.3 V).

In one example, the electronic circuit 100 includes an offset voltage source 134 coupled between the source of the second transistor 104 and the second input terminal 130 the auxiliary circuit 116. The offset voltage source 134 is provides an offset voltage Vos in addition to the voltage V_{OV_DET} at the source of the second transistor 104 as the second input to the auxiliary circuit 116 so that the V_{OV_DE}T+Vos would be equal to the VOUT_LDO and cause the auxiliary circuit 116 to generate a change, e.g., a pulse as discussed above, in the voltage adjustment signal COMP_OUT while the first transistor 102 is still in its saturation region. As such, the first transistor 102 will always stay in its saturation region without ever falling into the linear region even for a brief period of time.

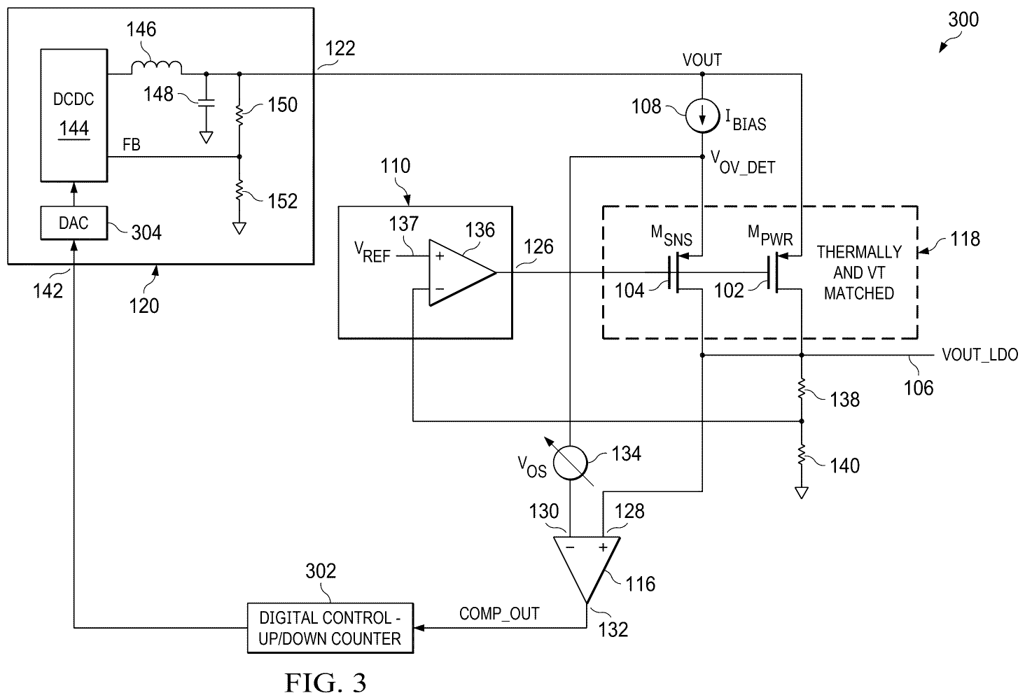

FIG. 3 depicts a schematic diagram of an electronic circuit 300, according to an embodiment of the present disclosure. Electronic circuit 300, in addition to the components of FIG. 1 discussed above, further includes a digital control counter 302 coupled between the output terminal 132 of the auxiliary circuit 116 and the input terminal 142 of the voltage converter 120. In one example, the digital control counter 302 is configurable to receive the voltage adjustment signal COMP_OUT from the auxiliary circuit 116 as its input, generate and provide a digital code/count as the voltage adjustment signal to the voltage converter 120 via an up and/or down digital counter implemented using, e.g., an internal clock. In one example, a digital-to-analog converter (DAC) 304 of the voltage converter 120 is configurable to convert the digital code into an analog signal, e.g., a DC voltage, as an input to the DC-DC converter 144 to control the supply voltage VOUT. In one example, as shown by FIG. 2B, the voltage converter 120 is configurable to keep reducing the supply voltage VOUT at the supply terminal 122 step-by-step (e.g., 0.025 V at a time), according to the digital code until the output voltage VOUT_LDO at the drain of the first transistor 102 is at or higher than the voltage V_{OV_DET} at the source of the second transistor 104. As such, the digital control counter 302 enables adaptive adjustment of the headroom of the LDO to the minimum required for the first transistor 102 to stay in the saturation region and the voltage adjustment signal COMP_OUT stays low. This keeps the first transistor 102 at optimum operating condition while staying in saturation.

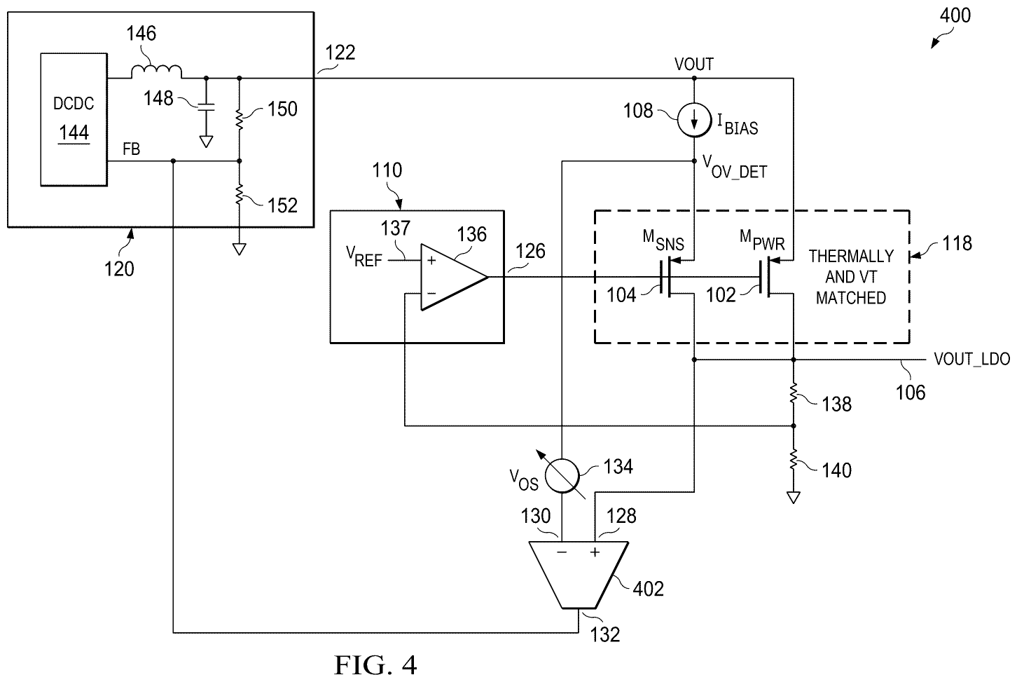

FIG. 4 depicts a schematic diagram of an example of an electronic circuit 400, wherein the auxiliary circuit 402 is an analog circuit configurable to generate an output current as the voltage adjustment signal according to the output voltage VOUT_LDO at the drain of the first transistor 102 and the voltage V_{OV_DET} at the source of the second transistor 104. In one example, the auxiliary circuit 402 includes a transconductance (Gm) amplifier configurable to generate the analog output current from the input voltages. Here, the output current provides a low frequency analog feedback to a supply voltage control loop through the voltage converter 120. In one example, the output current is an analog current proportional to the drain-source voltage V_{DSMPR} of the first transistor 102. In one example, once the drain-source voltage V_{DSMPR} of the first transistor 102 crosses the saturation threshold voltage V_{DSAT} the auxiliary circuit 402 is configurable to change a polarity of the output current to go in the direction and push the output current to be proportional to a difference between the drain-source voltage V_{DSMPR} and the saturation threshold voltage V_{DSAT} of the first transistor 102. According to the output current received from the auxiliary circuit 402 in both directions, the voltage converter 120 is configurable to adjust the supply voltage VOUT at the supply terminal 122 and to regulate headroom of the first transistor 102 at its optimum voltage at all times.

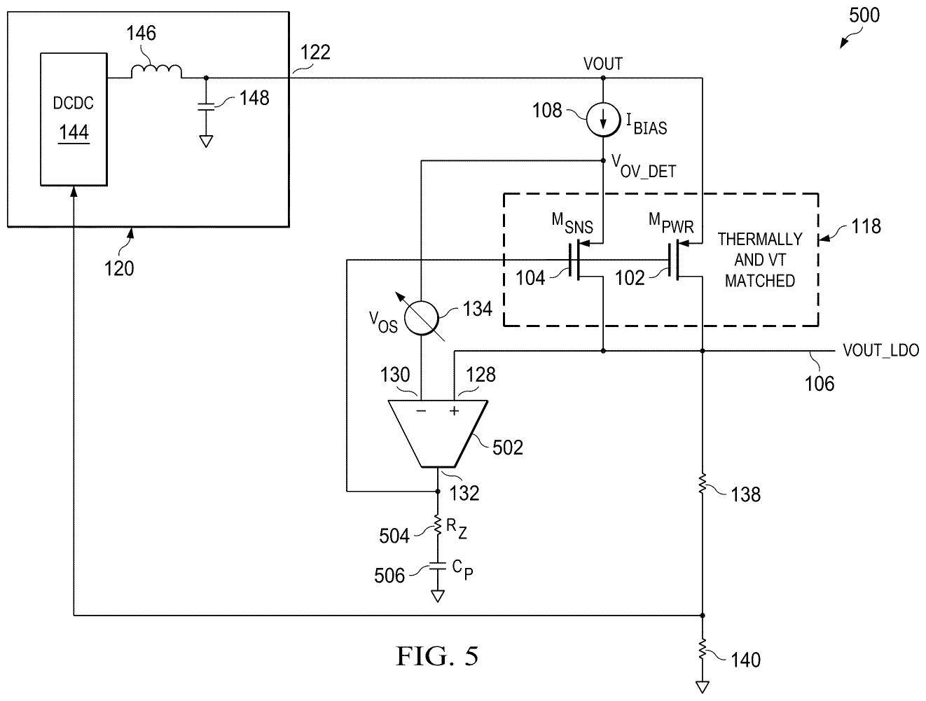

FIG. 5 depicts a schematic diagram of another example of an electronic circuit 500, wherein the auxiliary circuit 502 is an analog circuit. As the auxiliary circuit 402 of FIG. 4, the auxiliary circuit 502 is configurable to receive the output voltage VOUT_LDO at the drain of the first transistor 102 as its first input and the voltage V_{OV_DET} at the source of the second transistor 104 as its second input. Based on these inputs, the auxiliary circuit 502 generates a current control signal at its output terminal 132, which is coupled to the control terminal of the first transistor 102 and the control terminal of the second transistor 104, forming an inner feedback loop to control the gate voltage at the first transistor 102 and the second transistor 104. In one example, the auxiliary circuit 502 includes a transconductance (Gm) amplifier configurable to generate the current control signal as an analog signal similar to the auxiliary circuit 402 discussed above. In one example, the output terminal 132 of the auxiliary circuit 502 couples to an RC circuitry including a resistor (Rz) 504 and a capacitor (Cp) 506, wherein the RC circuitry converts the current control signal from a current signal to a voltage signal. In one example, the voltage converter 120 is configurable to receive the output voltage VOUT_LDO at the drain of the first transistor 102, as divided by the pair of resistors 138 and 140 at its input terminal 142, and forms an outer feedback loop to adjust the supply voltage VOUT at the supply terminal 122. In one example, the DC-DC converter 144 of the voltage converter 120 is configurable to regulate the supply voltage VOUT by compensating for a voltage drop at the output terminal 106 via the outer feedback loop.

Example embodiments of the present disclosure are summarized here. Other embodiments can also be understood from the entirety of the specification and the claims filed herein.

Example 1. An electronic circuit including: an output terminal; a voltage regulator including: a supply terminal; a reference input terminal; a first transistor having a control terminal, and first and second current path terminals, the first current path terminal of the first transistor coupled to the output terminal, the second current path terminal of the first transistor coupled to the supply terminal of the voltage regulator; a second transistor having a control terminal, and first and second current path terminals, the first current path terminal of the second transistor coupled to the output terminal, the second current path terminal of the second transistor coupled to the supply terminal of the voltage regulator, and the control terminal of the second transistor coupled to the control terminal of the first transistor; and a current source coupled between the supply terminal of the voltage regulator, and the second current path terminal of the second transistor, where the voltage regulator is configured to provide a regulated voltage at the output terminal based on the reference input terminal; and an auxiliary circuit configurable to: sense a voltage across the first and second current path terminals of the second transistor; and generate a voltage adjustment signal based on the sensed voltage.

Example 2. The electronic circuit of example 1, further including a voltage converter configurable to: receive the voltage adjustment signal; and adjust a supply voltage at the supply terminal based on the voltage adjustment signal.

Example 3. The electronic circuit of one of examples 1 or 2, where the voltage converter is a switching buck converter.

Example 4. The electronic circuit of one of examples 1 to 3, where the voltage converter is configured to increase the supply voltage by a predetermined amount in response to an assertion of the voltage adjustment signal.

Example 5. The electronic circuit of one of examples 1 to 4, where the voltage converter is configured to increase the supply voltage by a maximum amount in response to an assertion of the voltage adjustment signal.

Example 6. The electronic circuit of one of examples 1 to 5, where the voltage converter is configured to incrementally increase the supply voltage in response to an assertion of the voltage adjustment signal.

Example 7. The electronic circuit of one of examples 1 to 6, where the second transistor is a scaled down replica of the first transistor.

Example 8. The electronic circuit of one of examples 1 to 7, further including an amplifier having a first input coupled to the reference input terminal of the voltage regulator, a second input coupled to the output terminal, and an output coupled to the control terminal of the first transistor.

Example 9. The electronic circuit of one of examples 1 to 8, where the auxiliary circuit includes an amplifier having a first input coupled to the first current path terminal of the second transistor, a second input coupled to the second current path terminal of the second transistor, and an output configured to provide the voltage adjustment signal.

Example 10. The electronic circuit of one of examples 1 to 9, where the amplifier is a transconductance amplifier.

Example 11. The electronic circuit of one of examples 1 to 10, where the amplifier is an operational amplifier.

Example 12. The electronic circuit of one of examples 1 to 11, where the amplifier is a comparator.

Example 13. The electronic circuit of one of examples 1 to 12, further including an offset voltage source coupled between the second input of the amplifier and the second current path terminal of the second transistor.

Example 14. The electronic circuit of one of examples 1 to 13, where the current source is configurable to set a bias current flowing into the second current path of the second transistor such that a voltage between the control terminal of the second transistor and the second current path terminal of the second transistor equals to a threshold voltage of the first transistor.

Example 15. The electronic circuit of one of examples 1 to 14, where the auxiliary circuit is configured to assert the voltage adjustment signal when a voltage at the first current path terminal of the second transistor is higher than a voltage at the second current path terminal of the second transistor.

Example 16. The electronic circuit of one of examples 1 to 15, where asserting the voltage adjustment signal includes generating a pulse in the voltage adjustment signal.

Example 17. The electronic circuit of one of examples 1 to 16, where the auxiliary circuit is configured to assert the voltage adjustment signal in response to the first transistor entering a linear region.

Example 18. The electronic circuit of one of examples 1 to 17, further including: an offset voltage source coupled between the first configurable to provide an offset voltage in addition to the voltage at the source of the second transistor as the second input to the voltage analyzing circuit.

Example 19. The electronic circuit of one of examples 1 to 18, where the auxiliary circuit includes a counter configured to provide a count based on the sensed voltage, where the voltage adjustment signal is based on the count of the counter.

Example 20. The electronic circuit of one of examples 1 to 19, further including a voltage converter configured to reduce a supply voltage at the supply terminal according to the count.

Example 21. The electronic circuit of one of examples 1 to 20, where the voltage adjustment signal is a current signal.

Example 22. An electronic circuit including: an output terminal; a voltage regulator including: a supply terminal; a reference input terminal; a first transistor having a control terminal, and first and second current path terminals, the first current path terminal of the first transistor coupled to the output terminal, the second current path terminal of the first transistor coupled to the supply terminal of the voltage regulator; a second transistor having a control terminal, and first and second current path terminals, the first current path terminal of the second transistor coupled to the output terminal, the second current path terminal of the second transistor coupled to the supply terminal of the voltage regulator, and the control terminal of the second transistor coupled to the control terminal of the first transistor; a current source coupled between the supply terminal of the voltage regulator, and the second current path terminal of the second transistor; and a first amplifier having a first input coupled to the reference input terminal of the voltage regulator, a second input coupled to the output terminal, and an output coupled to the control terminal of the first transistor; and an auxiliary circuit including a second amplifier having a first input coupled to the first current path terminal of the second transistor, a second input coupled to the second current path terminal of the second transistor, and an output.

Example 23. The electronic circuit of example 22, further including a voltage converter having an output coupled to the supply terminal of the voltage regulator, and a control input coupled to the output of the second amplifier.

Example 24. An electronic circuit including: an output terminal; a supply terminal; a first transistor having a control terminal, and first and second current path terminals, the first current path terminal of the first transistor coupled to the output terminal, the second current path terminal of the first transistor coupled to the supply terminal; a second transistor having a control terminal, and first and second current path terminals, the first current path terminal of the second transistor coupled to the output terminal, the second current path terminal of the second transistor coupled to the supply terminal, and the control terminal of the second transistor coupled to the control terminal of the first transistor; a current source coupled between the supply terminal and the second current path terminal of the second transistor; a first amplifier having a first input coupled to a reference input terminal, a second input coupled to the output terminal, and an output coupled to the control terminal of the first transistor; and an auxiliary circuit including a second amplifier having a first input coupled to the first current path terminal of the second transistor, a second input coupled to the second current path terminal of the second transistor, and an output.

Example 25. The electronic circuit of example 24, further including a voltage converter having an input coupled to the output of the auxiliary circuit and an output coupled to the supply terminal.

Example 26. The electronic circuit of one of examples 24 or 25, further including a counter having an input coupled to the output of the auxiliary circuit, and an output coupled to the input of the voltage converter.

Example 27. The electronic circuit of one of examples 24 to 26, where the auxiliary circuit includes a transconductance amplifier having a first input coupled to the first current path terminal of the second transistor, a second input coupled to the second current path terminal of the second transistor, and an output coupled to the input of the voltage converter.

Example 28. The electronic circuit of one of examples 24 to 27, where the auxiliary circuit includes a transconductance amplifier having a first input coupled to the first current path terminal of the second transistor, a second input coupled to the second current path terminal of the second transistor, and an output coupled to the control terminals of the first transistor and the second transistor.

Example 29. An electronic circuit including: an output terminal; a supply terminal; a first transistor having a control terminal, and first and second current path terminals, the first current path terminal of the first transistor coupled to the output terminal, the second current path terminal of the first transistor coupled to the supply terminal; a second transistor having a control terminal, and first and second current path terminals, the first current path terminal of the second transistor coupled to the output terminal, the second current path terminal of the second transistor coupled to the supply terminal, and the control terminal of the second transistor coupled to the control terminal of the first transistor; a current source coupled between the supply terminal and the second current path terminal of the second transistor; an auxiliary circuit configurable to: sense a voltage across the first and second current path terminals of the second transistor; and generate a voltage adjustment signal based on the sensed voltage to the control terminals of the first transistor and the second transistor.

Example 30. The electronic circuit of example 29, further including a voltage converter configurable to: receive an output voltage at the output terminal as its input; adjust the supply voltage at the supply terminal according to the output voltage.

Example 31. The electronic circuit of one of examples 29 or 30, where the voltage converter is configured to increase the supply voltage by a predetermined amount in response to an assertion of the output voltage.

Example 32. The electronic circuit of one of examples 29 to 31, where the voltage converter is configured to increase the supply voltage by a maximum amount in response to an assertion of the output voltage.

Example 33. The electronic circuit of one of examples 29 to 32, where the voltage converter is configured to incrementally increase the supply voltage in response to an assertion of the output voltage.

Example 34. The electronic circuit of one of examples 29 to 33 where the current source is configurable to set a bias current flowing into the second current path of the second transistor such that a voltage between the control terminal of the second transistor and the second current path terminal of the second transistor equals to a threshold voltage of the first transistor.

Example 35. The electronic circuit of one of examples 29 to 34, further including an offset voltage source coupled between the source of the second transistor and the second input terminal of the auxiliary circuit and configurable to provide an offset voltage in addition to the voltage at the source of the second transistor as the second input to the auxiliary circuit.

Example 36. The electronic circuit of one of examples 29 to 35, where the auxiliary circuit is an electronic circuit configurable to generate an output current as the current control signal according to voltage at the drain of the first transistor and the voltage at the source of the second transistor.

Example 37. The electronic circuit of one of examples 29 to 36, where the electronic circuit includes a transconductance amplifier.

In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. An electronic circuit comprising:
an output terminal;
a voltage regulator comprising:
a supply terminal;
a reference input terminal;
a first transistor having a control terminal, and first and second current path terminals, the first current path terminal of the first transistor coupled to the output terminal, the second current path terminal of the first transistor coupled to the supply terminal of the voltage regulator;
a second transistor having a control terminal, and first and second current path terminals, the first current path terminal of the second transistor coupled to the output terminal, the second current path terminal of the second transistor coupled to the supply terminal of the voltage regulator, and the control terminal of the second transistor coupled to the control terminal of the first transistor; and
a current source coupled between the supply terminal of the voltage regulator, and the second current path terminal of the second transistor, wherein the voltage regulator is configured to provide a regulated voltage at the output terminal based on the reference input terminal; and
an auxiliary circuit configurable to:
sense a voltage across the first and second current path terminals of the second transistor; and
generate a voltage adjustment signal based on the sensed voltage.

2. The electronic circuit of claim 1, further comprising a voltage converter configurable to:
receive the voltage adjustment signal; and
adjust a supply voltage at the supply terminal based on the voltage adjustment signal.

3. The electronic circuit of claim 2, wherein the voltage converter is a switching buck converter.

4. The electronic circuit of claim 2, wherein the voltage converter is configured to increase the supply voltage by a predetermined amount in response to an assertion of the voltage adjustment signal.

5. The electronic circuit of claim 2, wherein the voltage converter is configured to increase the supply voltage by a maximum amount in response to an assertion of the voltage adjustment signal.

6. The electronic circuit of claim 2, wherein the voltage converter is configured to incrementally increase the supply voltage in response to an assertion of the voltage adjustment signal.

7. The electronic circuit of claim 1, wherein the second transistor is a scaled down replica of the first transistor.

8. The electronic circuit of claim 1, further comprising an amplifier having a first input coupled to the reference input terminal of the voltage regulator, a second input coupled to the output terminal, and an output coupled to the control terminal of the first transistor.

9. The electronic circuit of claim 1, wherein the auxiliary circuit comprises an amplifier having a first input coupled to the first current path terminal of the second transistor, a second input coupled to the second current path terminal of the second transistor, and an output configured to provide the voltage adjustment signal.

10. The electronic circuit of claim 9, wherein the amplifier is a transconductance amplifier.

11. The electronic circuit of claim 9, wherein the amplifier is an operational amplifier.

12. The electronic circuit of claim 9, wherein the amplifier is a comparator.

13. The electronic circuit of claim 9, further comprising an offset voltage source coupled between the second input of the amplifier and the second current path terminal of the second transistor.

14. The electronic circuit of claim 1, wherein the current source is configurable to set a bias current flowing into the second current path of the second transistor such that a voltage between the control terminal of the second transistor and the second current path terminal of the second transistor equals to a threshold voltage of the first transistor.

15. The electronic circuit of claim 1, wherein the auxiliary circuit is configured to assert the voltage adjustment signal when a voltage at the first current path terminal of the second transistor is higher than a voltage at the second current path terminal of the second transistor.

16. The electronic circuit of claim 15, wherein asserting the voltage adjustment signal comprises generating a pulse in the voltage adjustment signal.

17. The electronic circuit of claim 15, wherein the auxiliary circuit is configured to assert the voltage adjustment signal in response to the first transistor entering a linear region.

18. The electronic circuit of claim 1, further comprising: an offset voltage source coupled between the first configurable to provide an offset voltage in addition to the voltage at the source of the second transistor as the second input to the voltage analyzing circuit.

19. The electronic circuit of claim 1, wherein the auxiliary circuit comprises a counter configured to provide a count based on the sensed voltage, wherein the voltage adjustment signal is based on the count of the counter.

20. The electronic circuit of claim 19, further comprising a voltage converter configured to reduce a supply voltage at the supply terminal according to the count.

21. The electronic circuit of claim 1, wherein the voltage adjustment signal is a current signal.
